(19) United States
(12) Patent Application Publication
(10) Pub. No.: US 2022/0228568 A1
(43) Pub. Date: Jul. 21, 2022

(54) METHOD FOR ANALYZING WIND TURBINE BLADE COATING FATIGUE DUE TO RAIN EROSION

(71) Applicant: ZHEJIANG UNIVERSITY, Hangzhou City (CN)

(72) Inventors: Weifei HU, Hangzhou City (CN); Weiyi CHEN, Hangzhou City (CN); Zhenyu LIU, Hangzhou City (CN); Jianrong TAN, Hangzhou City (CN)

(21) Appl. No.: 17/566,606

(22) Filed: Dec. 30, 2021

Related U.S. Application Data
(63) Continuation of application No. PCT/CN2021/072812, filed on Jan. 20, 2021.

(30) Foreign Application Priority Data
Jan. 15, 2021 (CN) 202110055626.2

(51) Int. Cl. F03D 17/00; G06F 30/23; G06F 30/28

(52) U.S. Cl. CPC F03D 17/00; G06F 2113/06; G06F 30/28; G06F 30/23

(57) ABSTRACT

Disclosed is a method for analyzing wind turbine blade coating fatigue due to rain erosion. According to the method, a stochastic rain field model is established, and the coating fatigue life of the wind turbine blades is calculated based on a crack propagation theory. The present patent innovatively develops a stochastic rain field model considering the shape, size, impact angle, and impact speed of raindrops to simulate the raindrop impact process, analyzes the impact stress of raindrops on the blade coating by using a smooth particle hydrodynamics method and a finite element analysis method, calculates the impact stress of all raindrops in the random rainfall process by using a stress interpolation method, and carries out fatigue analysis for the blade coating based on the impact stress.

### CROSS-REFERENCE TO RELATED APPLICATIONS

The present application is a continuation of International Application No. PCT/CN2021/072812, filed on Jan. 20, 2021, which claims priority to Chinese Application No. 202110055626.2, filed on Jan. 15, 2021, the contents of both of which are incorporated herein by reference in their entireties.

### TECHNICAL FIELD

The present application relates to the field of wind turbine blade design, in particular to a method for analyzing wind turbine blade coating fatigue due to rain erosion.

### BACKGROUND

Wind turbine blades are frequently exposed to impacts from high-relative-speed objects such as rain, atmospheric particles and hail, especially at the tips of the blades. These impacts may lead to damage and peeling of the leading edge of the blade, thereby reducing the aerodynamic performance and power output of the wind turbine. With the continuous growth of the tip speed and rotor diameter of the wind turbine, it becomes more and more important to predict the fatigue life of the wind turbine blade coating due to rain erosion in the design stage.

At present, there is no effective solution in this aspect. The present application combines the stochastic rain field model, smoothed particle hydrodynamics and fatigue crack propagation theory to predict and calculate the fatigue life of the wind turbine blade coating. The existing impact approach and energy approach for calculating the impact stress of raindrops on the blade coating have some defects. It is difficult for the impact approach to consider the fluid-solid interaction in the process of raindrops impact, while it is difficult for the energy method to quantify the total transfer energy from the stochastic rain field to the blade coating of the wind turbine. At present, the calculation of the fatigue life of the wind turbine blade coating under rain erosion is usually implemented by using stress-life curve and Miner's hypothesis of linear accumulation, but the life calculated by this method is only limited to the fatigue crack initiation period. Usually, the fatigue failure of materials will go through three stages: crack initiation, crack stable propagation and crack unstable propagation. Traditional fatigue analysis and calculation methods cannot completely calculate the fatigue life of the wind turbine blade coating.

### SUMMARY

The present application aims to overcome the shortcomings of the prior art, and provides a method for analyzing wind turbine blade coating fatigue due to rain erosion. This method combines a stochastic rain field model, smoothed particle hydrodynamics and the fatigue crack propagation theory to predict and calculate the fatigue life of a wind turbine blade coating. Through effective modeling of natural rainfall, accurate analysis of raindrop impact stress on the wind turbine blade and comprehensive calculation of the fatigue life of the wind turbine blade coating, the fatigue life of a wind turbine blade coating due to rain erosion is accurately and effectively calculated.

The purpose of the present application is realized by the following technical solution.

The present application relates to a method for analyzing wind turbine blade coating fatigue due to rain erosion, a stochastic rain field model is used to effectively model the natural rainfall condition, smoothed particle hydrodynamics and stress interpolation are used to accurately analyze the stress of raindrop impacting the blade, and the fatigue crack propagation theory is used to comprehensively calculate the fatigue life of the blade coating; the method specifically comprises the following steps:

S1: establishing a plurality of stochastic rain field models according to different rain intensities I and rainfall durations tₛ;

S2: calculating stresses caused by different raindrops impacting the blades by using finite element analysis;

S3: calculating the impact stress of a coating in a stochastic rain field;

S4: calculating blade coating fatigue lives t_{I} under different rain intensities I;

S5: counting an annual rainfall duration t_{A} and a probability P_{I} of occurrence of each rain intensity;

S6: repeating steps S3 and S4 to obtain the fatigue life of the blade coating under different rain intensities I and calculating a wind turbine blade coating fatigue life t_{f} by using the following formula according to the calculation results of S4 and S5.

$${D}_{1 year} = {\sum }_{I} \frac{{P}_{I} \times {t}_{A}}{{t}_{I}}$$

$${t}_{f} = \frac{1}{{D}_{1 year}} .$$

Furthermore, S1 specifically comprises the following steps: firstly, determining a number k of raindrops in a stochastic rain field, then determining parameters of each raindrop, including a diameter, a shape, an impact angle θ and an impact position of each raindrop, and constructing the stochastic rain field model according to relevant attributes of the k raindrops;

(1) the number k of the raindrops is calculated by the following formula:

$$P ( N ( V ) = k ) = \frac{{( λ V )}^{k} {e}^{- λ V}}{k !}$$

$$λ = 48.88 {I}^{0.15}$$

where λ is an estimated number of raindrops per unit volume, P(N(V)=k) is a probability that there are k raindrops in a volume V, and I is a rain intensity in mm h⁻¹; raindrops are uniformly distributed in a space of the volume V;

the rainfall space volume Vis calculated by the following formula:

V=S×ν×tₛ

where S is a rainfall projection area, i.e., a blade coating area; ν is a relative velocity of raindrop impact, i.e., addition of a blade linear velocity with a raindrop velocity; tₛ is a rainfall duration;

(2) the diameter of each raindrop is calculated by the following formula:

$$F = 1 - exp [ - {( \frac{d}{1.3 {I}^{0.232}} )}^{2.25} ]$$

where F is a cumulative distribution function of a raindrop size d, d is the raindrop size in mm, and I is the rain intensity in mm h⁻¹;

(3) determination of the shape of the raindrop is to determine a type of raindrop according to an occurrence probability of a type of raindrop, and to carry out geometric modeling according to specific types;

the raindrop has the shape of one of flat ellipsoid, spindle ellipsoid or perfect sphere, the occurrence probabilities of which are 27%, 55% and 18% respectively; for perfect-sphere raindrops, modeling is directly implemented according to a raindrop radius; for flat-ellipsoid and spindle-ellipsoid raindrops, geometric modeling of raindrops is completed by an axial ratio formula:

a=1.030−0.124r₀

where α is the axial ratio of a minor axis to a major axis, r₀ is the equivalent perfect-sphere raindrop radius, i.e., r₀=d/2 ;

(4) the impact angle 0 of the raindrop follows a uniform distribution of [0, 90°];

(5) the impact position of the raindrop is any position in the blade coating area and is evenly distributed.

Furthermore, S2 specifically comprises the following substeps:

S2.1: constructing a blade model, meshing, setting properties of related composite materials, and setting constraint conditions:

S2.2: according to different sizes and shapes of raindrops, construing different single raindrops, meshing, setting an impact speed and impact angle of the raindrops, using finite element analysis software (e.g., Abaqus) combined with a smooth fluid dynamics method to implement simulation analysis, and calculating the impact stress of a single raindrop;

S2.3: obtaining Von Mises stresses of various sites on the blade coating in the finite element analysis as the impact stresses; as an embodiment, MATLAB can be used for obtaining the stress;

S2.4: repeating steps S2.2-S2.3 to calculate the impact stress of the raindrops under various conditions, including a combination of different raindrop diameters, different raindrop shapes, different impact angles and different impact speeds, for example, 9 types of raindrop diameters (d=1, 2, 3, 4, 5, 6, 7, 8, 9 mm), 3 types of raindrop shapes (flat ellipsoid, spindle ellipsoid, perfect sphere) and 6 types of impact angles (θ=15°, 30°, 45°, 60°,75°, 90°) and one impact speed (v=90 ms⁻¹)

Furthermore, S3 specifically includes the following substeps:

S3.1: according to the rain field model constructed by S1, after determining the size, shape, impact angle and speed of a single random raindrop, a circular domain with the impact point as a center and N times of the raindrop diameter as the radius being considered as the area influenced by raindrop impact, and N is 9-11;

S3.2: choosing the same type of raindrop shape according to the stress of the raindrop impact in a series of cases obtained in step S2, and searching for stress results of the impact cases that have the closest raindrop diameter, impact angle, and impact speed to interpolate the stress in the circular area;

S3.3: repeat steps S3.1-S3.2 for each raindrop until all the impact stresses caused by k raindrops on the blade are calculated.

Furthermore, S4 specifically includes the following substeps:

S4.1: selecting the rain intensity I and the rainfall duration tₛ of a single simulation, and calculating the impact stress of the coating in the stochastic rain field according to steps S1 to S3;

S4.2: selecting a local maximum stress and a neighboring minimum stress, or selecting a local minimum stress and a neighboring maximum stress to constitute a half stress cycle, and splitting an impact stress curve into a plurality of half-cyclic stresses with constant amplitudes;

S4.3: for each half-cyclic stress in S4.2, calculating the number of allowable stress cycles N_{f} by using the following formula:

$${σ}_{a}^{′} = \frac{{σ}_{a} UTS}{UTS - {σ}_{m}}$$

$${N}_{f} = {( \frac{{σ}_{a}^{′}}{{σ}_{f}} )}^{1 / b}$$

where σ′ₐ is the corrected stress amplitude, σₐ, is the stress amplitude, σₘ is the mean stress, UTS is the ultimate tensile strength, σ_{f} is the fatigue strength coefficient, b is the fatigue strength exponent, UTS, σ_{f} and b are all inherent properties of a coating material, which can be obtained through experiments, while σₐ, and σₘ can be calculated according to the maximum stress and minimum stress of the half-cyclic stress;

S4.4: repeating step S4.3 until the number of the allowable stress cycles N_{f} of all half-cyclic stresses is calculated; according to Miner's rule for damage accumulation, a fatigue damage caused by all half-cyclic stresses caused by a raindrop impacting the blade is

$$D = {\sum }_{i} \frac{0.5}{{N}_{f}^{i}}$$

S4.5: repeating steps S4.2-S4.4 until the fatigue damage Dₛ caused by the impact stress of k raindrops on the blade in the rainfall duration tₛ is calculated, and calculating the fatigue life tᵢₙᵢₜᵢₐₜᵢₒₙ of a crack initiation period by the following formula:

$${t}_{initiation} = \frac{{t}_{s}}{{D}_{s}}$$

S4.6: for each half-cyclic stress in S4.2, iteratively calculating a crack length by the following formula:

aᵢ₊₁=aᵢ+0.5×C[Y(σₘₐₓ−σₘᵢₙ) \sqrt{πaᵢ}]^{m}

where aᵢ₊₁ is a crack length after the half-cyclic stress, aᵢ is a crack length before the half-cyclic stress; C and m are inherent properties of the material, which are obtained through material fatigue experiments; a value of Y is determined by a crack shape, σₘₐₓ is the maximum stress of the half-cyclic stress and σₘᵢₙ is the minimum stress of the half-cyclic stress;

S4.7: repeating steps S4.2 and S4.6 until the crack length a caused by the impact stress of k raindrops on the blade in the rainfall duration tₛ is calculated;

S4.8: if the rain intensity I is greater than or equal to 10 mm h⁻¹, proceeding to step S4.9; if the rain intensity I is less than 10 mm h⁻¹, proceeding to step S4.1;

S4.9: repeating steps S4.1, S4.2, S4.6, S4.7, and the rainfall duration increases continuously, while the crack length increases continuously until the crack length meets the following formula or the crack length is greater than a coating thickness, considering that a crack stable propagation period is completed:

Yσₘₐₓ\sqrt{πa_{now}}>K_{C}

where a_{now} is a current crack length, K_{C} is a fracture toughness, which is an inherent property of the material and can be measured by experiments; when the crack length meets the above conditions, the rainfall duration is the fatigue life during the crack stable propagation period;

S4.10: when the rain intensity I is low, calculating an equivalent stress range Δσ within the rainfall duration tₛ by the following formula, and using a constant amplitude cyclic stress of the equivalent stress range Δσ to replace all varied-amplitude cyclic stresses within the rainfall duration I′ₛ:

$$Δ σ = \{ \begin{matrix}{\{ \frac{2}{{N}_{t} ( m - 2 ) {C ( Y \sqrt{π} )}^{m}} [ {a}_{0}^{( 1 - \frac{m}{2} )} - {a}^{( 1 - \frac{m}{2} )} ] \}}^{\frac{1}{m}} , & m \neq 2 \\ {[ \frac{1}{{{CN}_{t} ( Y \sqrt{π} )}^{m}} ln ( \frac{a}{{a}_{0}} ) ]}^{\frac{1}{m}} , & m = 2\end{matrix}$$

where a₀ is an initial crack length, a is a crack length after the rainfall duration tₛ and Nₜ is the number of all stress cycles in the rainfall duration tₛ;

the number of allowable stress cycles N_{c} during the crack stable propagation period is calculated by the following formula:

$${N}_{c} = \{ \begin{matrix}\frac{2}{( m - 2 ) {C ( Y Δ σ \sqrt{π} )}^{m}} [ {a}_{0}^{( 1 - \frac{m}{2} )} - {a}_{c}^{( 1 - \frac{m}{2} )} ] , & m \neq 2 \\ \frac{1}{{C ( Y Δ σ \sqrt{π} )}^{m}} ln ( \frac{{a}_{c}}{{a}_{0}} ) , & m = 2\end{matrix} \\ {a}_{C} = {( \frac{{K}_{C}}{Y {σ}_{MAX}} )}^{2} / π$$

where σ_{MAX} is the maximum stress in the rainfall duration tₛ;

the fatigue life of the crack stable propagation period is calculated by the following formula:

$${t}_{propagation} = \frac{{N}_{c}}{{N}_{t}} {t}_{s}$$

S4.11: calculating the fatigue life of the coating at a certain point under the rain intensity I by the following formula:

t_{IP}=tᵢₙᵢₜᵢₐₜᵢₒₙ+t_{propagation}

S4.12: repeating steps S4.1-S4.12 to calculate the fatigue life of each point of the coating, ranking the fatigue lives of all points from small to large, and taking the fatigue life of the 84th percentile as the fatigue life t_{I} of the whole coating.

Furthermore, S5 specifically includes the following substeps:

S5.1: obtaining annual rainfall data of an area where the wind turbine is located according to relevant statistical data;

S5.2: statistically processing the rainfall data, and obtaining an annual rainfall duration t_{A} and a probability of occurrence of each rain intensity P_{I} in the area (i.e., a probability density function PDF or a probability mass function PMF).

The present application has the following beneficial effects:

(1) the stochastic rain field model proposed by the present application takes the raindrop shapes (perfect sphere, flat ellipsoid and spindle ellipsoid) and the real raindrop sizes into consideration, and the stochastic rain field model well reflects a real rain field situation.

(2) The present application uses the smooth particle hydrodynamics (SPH) and stress interpolation method to calculate the impact stress of raindrops in the process of random rainfall, and the method can effectively and accurately calculate the impact stress of raindrops on the coating, while ensuring that the calculation time is not too long.

(3) According to the fatigue crack propagation theory, the fatigue life of the coating in the crack initiation period and the fatigue life in the crack stable propagation period are completely calculated, so that the calculated fatigue life is more accurate.

### BRIEF DESCRIPTION OF DRAWINGS

FIG. 1 is a flow chart of the method of the present application;

FIG. 2 is a schematic diagram of the method of the present application;

FIG. 3 is a schematic diagram of the raindrop shape and impact angle;

FIG. 4 is a simulation diagram of a stochastic rain field under four rain intensities, (a) 1 mm h⁻¹, (b) 10 mm h⁻¹, (c) 20 mm h⁻¹, and (d) 50 mm h⁻¹;

FIG. 5 is a model view of a tip panel of a blade;

FIG. 6 is a stress cloud of a single raindrop impacting the blade at eight intervals (0 μs, 10 μs, 20 μs, 30 μs, 40 μs, 50 μs);

FIG. 7 is an interpolation calculation result diagram of an impact stress of a raindrop with a diameter of 2.5 mm and an impact angle of 80°, in which (a) is a comparison diagram of an stress interpolation calculation result and raindrop impact stresses under four closest impact cases, and (b) is a comparison diagram of a stress interpolation calculation result and a finite element analysis calculation result;

FIG. 8 is a probability mass function diagram of rain intensity in Miami, Florida.

### DESCRIPTION OF EMBODIMENTS

The purpose and effect of the present application will become more clear from the following detailed description of the present application according to the drawings and preferred embodiments. It should be understood that the specific embodiments described here are only used to explain, not to limit, the present application.

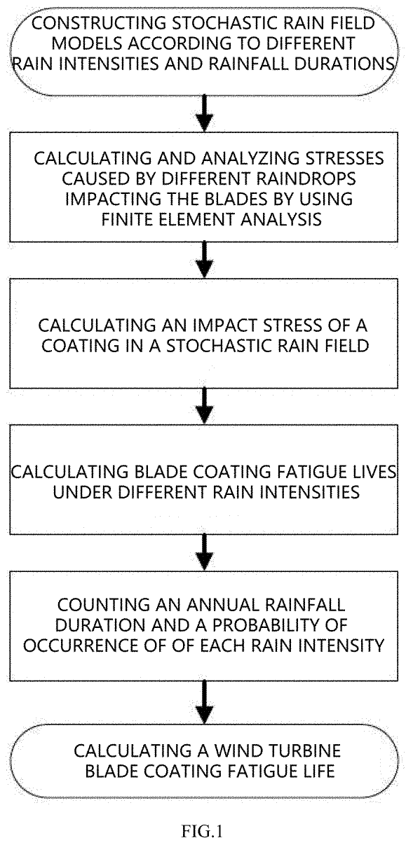

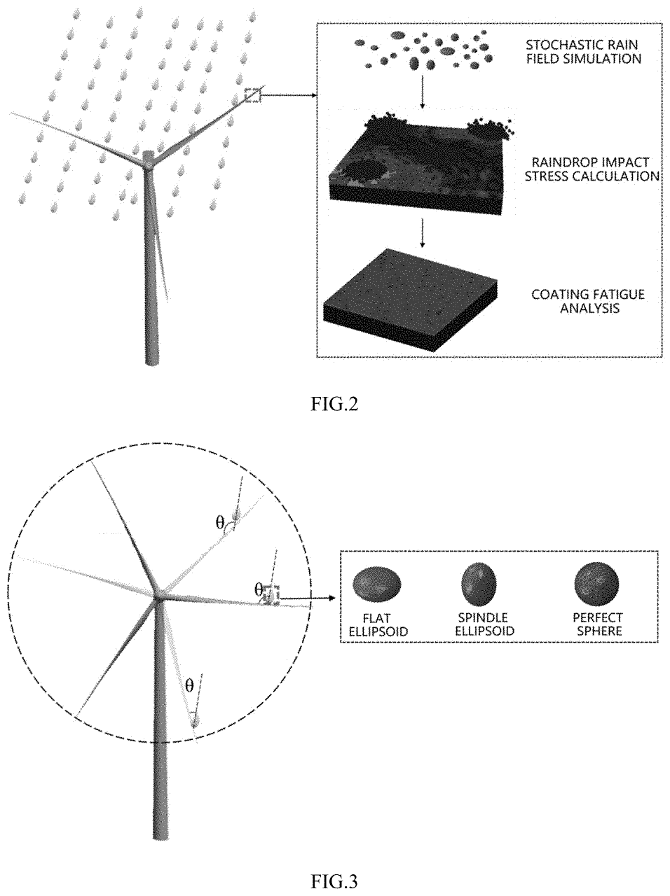

According to the method for analyzing wind turbine blade coating fatigue due to rain erosion, a stochastic rain field model is used to effectively model the natural rainfall condition, smoothed particle hydrodynamics and stress interpolation are used to accurately analyze the stress of raindrops impacting the blades, and the fatigue crack propagation theory is used to comprehensively calculate the fatigue life of the blade coating. The fatigue life of a blade coating of the wind turbine located in Miami, Florida is predicted and calculated. The specific flow chart is shown in FIG. 1 and the schematic diagram is shown in FIG. 2, which specifically includes the following steps:

S1, a plurality of stochastic rain field models are established according to different rain intensities I and rainfall durations tₛ;

S1.1, the number k of the raindrops is calculated by the following formula:

$$P ( N ( V ) = k ) = \frac{{( λ V )}^{k} {e}^{- λ V}}{k !} \\ λ = 48.88 {I}^{0.15} \qquad ( V )$$

where λ is an estimated number of raindrops per unit volume, P(N(V)=k) is a probability that there are k raindrops in a volume V, and I is a rain intensity (mm h⁻¹); raindrops are uniformly distributed in a space of the volume V;

the rainfall space volume Vis calculated by the following formula:

V=S×ν×tₛ

where S is a rainfall projection are (i.e., a blade coating area), ν is a relative velocity of raindrop impact (addition of a blade linear velocity with a raindrop velocity), and tₛ is a rainfall duration; a random number conforming to the above probability distribution is generated in MAILAB to obtain the raindrop number k;

S1.2, the diameter of each raindrop is calculated by the following formula:

$$F = 1 - exp [ - {( \frac{d}{1.3 {I}^{0.232}} )}^{2.25} ]$$

where F is a cumulative distribution function of a raindrop size d, d is the raindrop size (mm), and I is the rain intensity (mm h⁻¹); raindrops are uniformly distributed in a space of volume V, and the raindrop size d is obtained by generating a random number conforming to the above probability distribution in MATLAB;

S1.3, the shape of the raindrop includes perfect sphere, flat ellipsoid and spindle ellipsoid; for ellipsoidal raindrops, there is a minor axis and a major axis, an axial ratio of which is α which can be calculated by the following formula:

a=1.030−0.124r₀

where r₀ is an equivalent perfect sphere raindrop radius, i.e., r₀=d/2 ;

Flat-ellipsoid raindrops have the longest axis in the horizontal plane, while spindle-ellipsoid raindrops have the longest axis perpendicular to the horizontal plane. The horizontal cross-sectional area of flat-ellipsoid raindrops and spindle-ellipsoid raindrops is assumed to be a circle and the vertical cross-sectional area is an ellipse, so the geometric modeling of raindrops can be completed by the axis ratio formula. According to relevant data, the probabilities of occurrence of flat-ellipsoid raindrops, spindle-ellipsoid raindrops and perfect-sphere raindrops are 27%, 55% and 18% respectively, as shown in FIG. 3;

S1.4: the impact angle θ of the raindrop follows a uniform distribution of [0, 90°]; the impact positions of raindrops are any positions in the blade coating area, which are evenly distributed, as shown in FIG. 3;

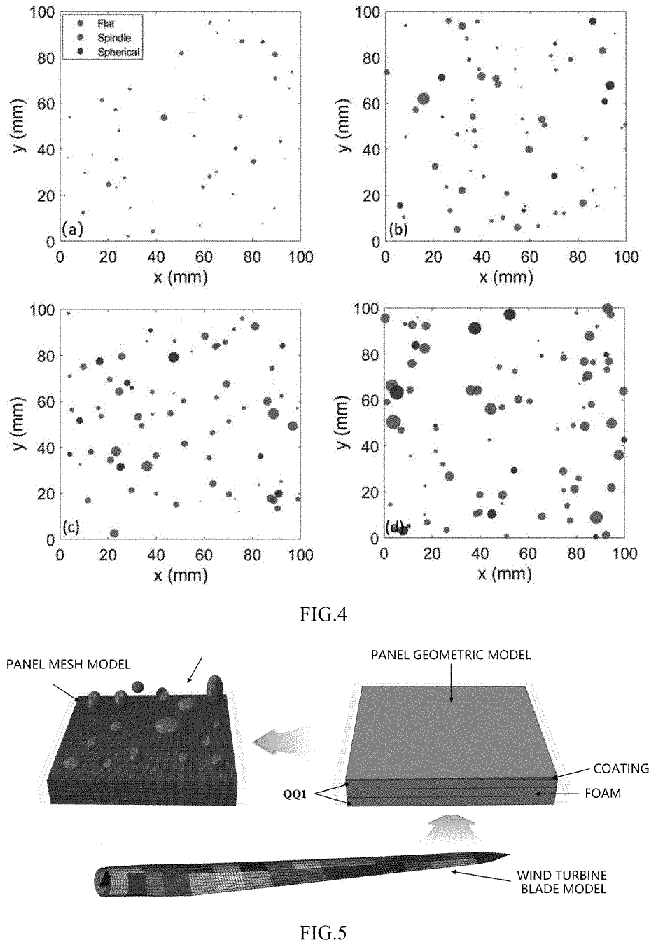

S1.5: for each raindrop, steps S1.2-S1.4 are repeated to determine the related attributes of each raindrop until the related attributes of k raindrops are determined, as shown in FIG. 4;

S2: stresses caused by different raindrops impacting the blades are calculated and analyzed by using finite element analysis;

S2.1: a blade model is constructed, and meshing is carried out; in order to control the calculation amount, only a finite element model is built for one panel at the tip of the blade, as shown in FIG. 5, and properties of a composite material are set; as shown in Table 1 below, epoxy resin is used as the coating, and the bottom and side of the panel are set to be completely constrained:

TABLE 1
Attribute table of the composite material of the blade

| | Material type | | |
|---|---|---|---|
| Material attribute | Coating | QQ1 | Foam |
| Longitudinal Young’s modulus E₁ (GPa) | 3.44 | 33.1 | 0.256 |
| Transverse Young’s modulus E₂ (GPa) | 3.44 | 17.1 | 0.256 |
| Poisson ratio’s v₁₂ | 0.3 | 0.27 | 0.33 |
| Shear modulus G₁₂ (GPa) | 1.38 | 6.29 | 0.098 |
| Density ρ (kg/m³) | 1235 | 1919 | 200 |

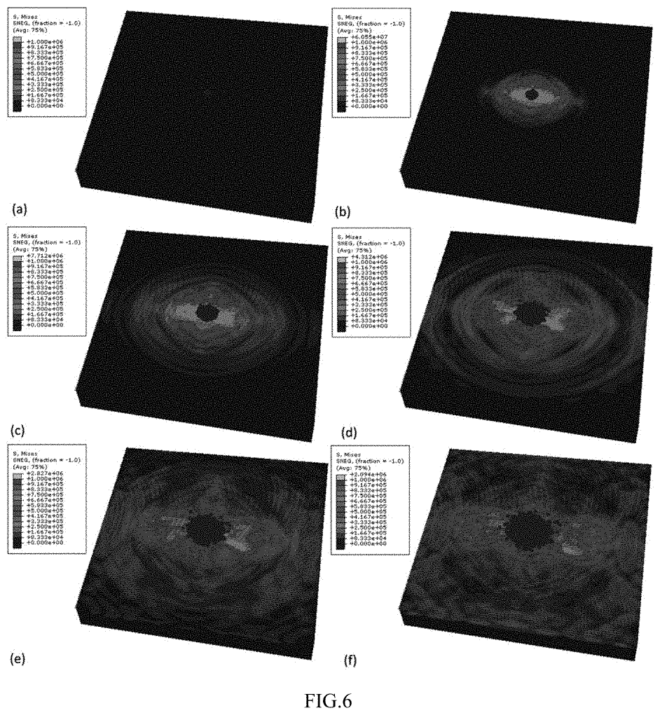

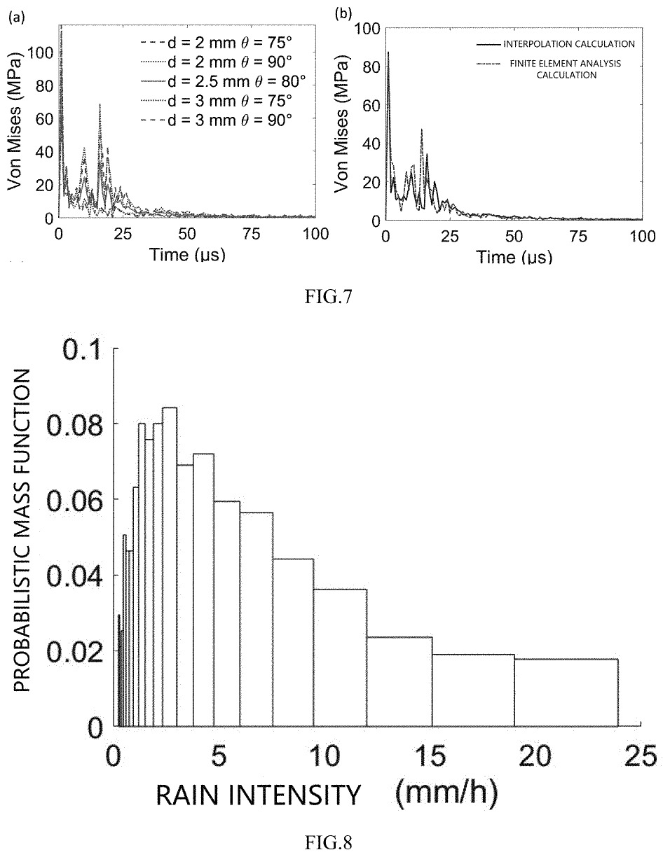

S2.2: according to different sizes and shapes of raindrops, different single raindrops are constructed, meshing is carried out, an impact speed and impact angle of the raindrops are set, a smoothed particle hydrodynamics (SP1-1) method in Abaqus finite element analysis software is used to calculate the impact stress of a single raindrop, as shown in FIG. 6;

S2.3: Von Mises stresses of various sites on the blade coating in the finite element analysis is obtained using MATLAB as the impact stresses;

S2.4: steps S2.2-S2.3 are repeated, and the raindrop impact stresses under 162 cases are simulated and calculated, namely, nine raindrop diameters (d=1, 2, 3, 4, 5, 6, 7, 8, and 9 mm), three raindrop shapes (flat ellipsoid, spindle ellipsoid, and perfect sphere), six impact angles (θ=15°, 30°, 45°, 60°,75°, 90°)and one impact speed (v =90 ms ¹);

S3: an impact stress of a coating in a stochastic rain field is calculated;

S3.1: according to the rain field model constructed by S1, after determining the size, shape, impact angle and speed of a single random raindrop, a circular domain with an impact point as a center and N times of the raindrop diameter as the radius is considered as the area influenced by raindrop impact;

S3.2: the same type of raindrop shape is chosen according to the stress of the raindrop impact in a series of cases obtained in step S2, and stress results of the impact cases calculated in S2 that have the closest raindrop diameter, impact angle, and impact speed are searched to interpolate the stress in the circular area;

S3.3: steps S3.1-S3.2 are repeated for each raindrop until all the impact stresses caused by k raindrops on the blade are calculated;

S4: blade coating fatigue lives t₁ under different rain intensities I are calculated;

S4.1: the rain intensity I and the rainfall duration tₛ (eg., 10 min) of a single simulation are selected, and the impact stress of the coating in the stochastic rain field is calculated according to steps S1 to S3;

S4.2: The actual impact stress has varied stress amplitudes due to the randomness of raindrop impact ; for cycle-by-cycle fatigue analysis, a simple range counting method is used to count all half-cyclic stresses, i.e., selecting a local maximum (minimum) stress and a neighboring minimum (maximum) stress to constitute a half stress cycle, by which, a complex impact stress curve is split into a plurality of half-cyclic stresses with constant amplitudes;

S4.3: for each half-cyclic stress in S4.2, the number of allowable stress cycles N_{f} is calculated by using the following formula:

$${σ}_{a}^{′} = \frac{{σ}_{a} UTS}{UTS - {σ}_{m}}$$

$${N}_{f} = {( \frac{{σ}_{a}^{′}}{{σ}_{f}} )}^{1 / b}$$

where σ′ₐ is the corrected stress amplitude, σₐ is the stress amplitude, σₘ is the mean stress, UTS is the ultimate tensile strength, σ_{f} is the fatigue strength coefficient, b is the fatigue strength exponent, UTS=73.3 MPa, σ_{f}=83.3 MPa, b=−0.117. σₐ and σₘ can be calculated according to the maximum stress and minimum stress of the half-cyclic stress;

S4.4: step S4.3 are repeated until the number of the allowable stress cycles N_{f} of all half-cyclic stresses is calculated; according to Miner's rule for damage accumulation, a fatigue damage caused by all half-cyclic stresses caused by a raindrop impacting the blade is

$$D = {\sum }_{i} \frac{0.5}{{N}_{f}^{i}}$$

S4.5: steps S4.2-S4.4 are repeated until the fatigue damage Dₛ caused by the impact stress of k raindrops on the blade in the rainfall duration tₛ is calculated, and the fatigue life t_{dinitiation} of a crack initiation period is calculated by the following formula:

$${t}_{initiation} = \frac{{t}_{s}}{{D}_{s}}$$

S4.6: for each half-cyclic stress in S4.2, a crack length is iteratively calculated by the following formula:

aᵢ₊₁=aᵢ+0.5×C[Y(σₘₐₓ−σₘᵢₙ)\sqrt{πaᵢ}]^{m}

where aᵢ₊₁ is a crack length after the half-cyclic stress, aᵢ is a crack length before the half-cyclic stress; C=9.7, m=0.08; the value of Y is determined by a crack shape, and Y=1 in this embodiment; σₐ is the maximum stress of the half-cyclic stress and σₘᵢₙ is the minimum stress of the half-cyclic stress;

S4.7: steps S4.2 and S4.6 are repeated until the crack length a caused by the impact stress of k raindrops on the blade in the rainfall duration tₛ is calculated;

S4.8: if the rain intensity I is greater than or equal to 10 mm h⁻¹, proceeding to step S4.9; if the rain intensity I is less than 10 mm h⁻¹, proceeding to step S4.1;

S4.9: steps S4.1, S4.2, S4.6, S4.7 are repeated, and the rainfall duration increases continuously, while the crack length increases continuously until the crack length meets the following formula or the crack length is greater than a coating thickness, it is considered that a crack stable propagation period is completed:

Yσₘₐₓ\sqrt{π_{now}}>K_{C}

where, a_{now} is a current crack length, K_{C} is a fracture toughness, which is an inherent property of the material, K_{c}=0.59 MPa h^{1/2} in this embodiment; when the crack length meets the above conditions, the rainfall duration is the fatigue life during the crack stable propagation period;

S4.10: when the rain intensity I is low, the method of S4.9 needs a lot of iterative calculation, which takes a long time, so the method of S4.10 is proposed; an equivalent stress range Δσ within the rainfall duration tₛ is calculated by the following formula, and a constant amplitude cyclic stress of the equivalent stress range Δσ is used to replace all varied-amplitude cyclic stresses within the rainfall duration tₛ:

$$Δ σ = \{ \begin{matrix}{\{ \frac{2}{{N}_{t} ( m - 2 ) {C ( Y \sqrt{π} )}^{m}} [ {a}_{0}^{( 1 - \frac{m}{2} )} - {a}^{( 1 - \frac{m}{2} )} ] \}}^{\frac{1}{m}} , & m \neq 2 \\ {[ \frac{1}{C {{N}_{t} ( Y \sqrt{π} )}^{m}} ln ( \frac{a}{{a}_{0}} ) ]}^{\frac{1}{m}} , & m = 2\end{matrix}$$

where a₀ is an initial crack length, a₀=12 μm, a is a crack length after the rainfall duration tₛ and Nₜ is the number of all stress cycles in the rainfall duration tₛ;

the number of allowable stress cycles N_{c} during the crack stable propagation period is calculated by the following formula:

$${N}_{c} = \{ \begin{matrix}\frac{2}{( m - 2 ) {C ( Y Δ σ \sqrt{π} )}^{m}} [ {a}_{0}^{( 1 - \frac{m}{2} )} - {a}_{c}^{( 1 - \frac{m}{2} )} ] , & m \neq 2 \\ \frac{1}{{C ( Y Δ σ \sqrt{π} )}^{m}} ln ( \frac{{a}_{c}}{{a}_{0}} ) , & m = 2\end{matrix} \\ {a}_{C} = {( \frac{{K}_{C}}{Y {σ}_{MAX}} )}^{2} / π$$

where σ_{MAX} is the maximum stress in the rainfall duration tₛ;

the fatigue life of the crack stable propagation period is calculated by the following formula:

$${t}_{propagation} = \frac{{N}_{c}}{{N}_{t}} {t}_{s}$$

S4.11: the fatigue life of the coating at a certain point under the rain intensity I is calculated by the following formula:

t_{IP}=tᵢₙᵢₜᵢₐₜᵢₒₙ+t_{propagation}

S4.12: steps S4.1-S4.12 are repeated to calculate the fatigue life of each point of the coating, the fatigue lives of all points are ranked from small to large, and the fatigue life of the 84th percentile is taken as the fatigue life t₁ of the whole coating;

S5: an annual rainfall duration t_{A} and a probability P_{I} of occurrence of each rain intensity are counted;

S5.1: annual rainfall data of an area where the wind turbine is located are obtained according to relevant statistical data;

S5.2: the rainfall data are statistically processed to obtain an annual rainfall duration t_{A} and a probability of occurrence of each rain intensity P_{I} in the area (i.e., the probability density function PDF or probability mass function PMF, as shown in FIG. 8.)

S6: steps S3 and S4 are repeated to obtain the fatigue life of the blade coating under different rain intensities;

TABLE 2
Fatigue life of a wind turbine blade coating under various rain intensities

| Rain intensity | Fatigue life | Rain intensity | Fatigue life |
|---|---|---|---|
| (mm h⁻¹)) | (h) | (mm h⁻¹) | (h) |
| 20 | 4.2 | 10 | 192.7 |
| 19 | 6.9 | 9 | 470.4 |
| 18 | 8.3 | 8 | 1254.5 |
| 17 | 14 | 7 | 1989.2 |
| 16 | 15.5 | 6 | 4155.7 |
| 15 | 31.3 | 5 | 14463 |
| 14 | 45.4 | 4 | 53673.3 |
| 13 | 46.4 | 3 | 200250 |
| 12 | 79 | 2 | 1590481.9 |
| 11 | 142.5 | 1 | 44960142.3 |

According to the statistical results of S5, combined with the fatigue life of the wind turbine blade coating under various rain intensities in Table 2, the following formula is used to calculate the fatigue life t_{f} of the wind turbine blade coating.

$${D}_{1 year} = {\sum }_{I} \frac{{P}_{I} \times {t}_{A}}{{t}_{I}} \\ {t}_{f} = \frac{1}{{D}_{1 year}}$$

The fatigue life of the wind turbine in Miami, Florida is calculated to be 1.3 years.

In order to verify the accuracy of the proposed analysis method, according to the above calculation flow, the total fatigue life of the blade coating is recalculated according to the rainfall data in the relevant experimental research made by Bech et al. And the total fatigue life of the blade coating is compared with the fatigue life calculation results in the relevant experimental research of the foreign scholars Bech et al., as shown in Table 4, the annual wind turbine life loss percentage is the annual rainfall time under each rain intensity divided by the fatigue life. Under the condition of using the same rainfall data, the expected fatigue life calculated by the method of the present application is 2.1 years, slightly longer than that obtained by Bech. This is mainly because the calculation flow proposed by the present application involves more complicated and realistic calculation methods, for example, various impact angles and raindrop shapes are considered in the simulation of a stochastic rain field.

TABLE 3
Comparison of the total fatigue life in this study and from
Bech's result under different rain intensities

| | | | | Annual | Fatigue lives | |
|---|---|---|---|---|---|---|
| | | | Fatigue life | wind | under various | Annual wind |
| | | | under various | turbine life | rain | turbine life |
| | | | rain | loss | intensities | loss |
| Rain | Annual | Tip | intensities | percentage | (the result of | percentage |
| intensity | rain time | speed | (Bech's | (Bech's | this method) | (result of this |
| (mm h⁻¹) | (h yr⁻¹) | (ms⁻¹) | result) (h) | result) (%) | (h) | method) (%) |
| 20 | 1.8 | 90 | 3.5 | 51 | 4.2 | 42.9 |
| 10 | 8.8 | 90 | 79 | 11 | 192.7 | 4.6 |
| 5 | 88 | 90 | 3600 | 2.4 | 14463 | 0.6 |
| 2 | 263 | 90 | 7.5 × 10⁵ | 3.5 × 10⁻² | 1.6 × 10⁶ | 1.6 × 10⁻² |
| 1 | 438 | 90 | 2.8 × 10⁹ | 1.6 × 10⁻⁵ | 4.5 × 10⁷ | 9.7 × 10⁻⁴ |

| | | |
|---|---|---|
| Total percentage of annual wind turbine life loss (%): | 64.4 | 48.1 |
| Expected fatigue life of wind turbine (year): | 1.6 | 2.1 |

The example effectively shows that the fatigue life of the wind turbine blade coating in a certain area can be effectively predicted by the calculation method of the present application in combination with the historical rainfall data of the area.

It can be understood by those skilled in the art that the above description is only the preferred examples of the present application, and is not used to limit the present application. Although the present application has been described in detail with reference to the foregoing examples, those skilled in the art can still modify the technical solutions described in the foregoing examples or replace some of their technical features equivalently. Within the spirit and principle of the present application, the modification, equivalent replacement and the like should be included within the scope of protection of the present application.

What is claimed is:

1. A method for analyzing wind turbine blade coating fatigue due to rain erosion, comprising the following steps:
S1 : establishing a plurality of stochastic rain field models according to different rain intensities I and rainfall durations tₛ;
S2: calculating stresses caused by different raindrops impacting the blades by using finite element analysis;
S3: calculating an impact stress of a coating in a stochastic rain field;
S4: calculating blade coating fatigue lives t_{I} under different rain intensities I;
S5: counting an annual rainfall duration t_{A} and a probability P_{I} of occurrence of each rain intensity;
S6: repeating steps S3 and S4 to obtain the fatigue life of the blade coating under different rain intensities I, and calculating a wind turbine blade coating fatigue life t_{f} by using following formula according to the calculation results of S4 and S5:
$${D}_{1 year} = {\sum }_{I} \frac{{P}_{I} \times {t}_{A}}{{t}_{I}} \\ {t}_{f} = \frac{1}{{D}_{1 year}} .$$

2. The method for analyzing wind turbine blade coating fatigue due to rain erosion according to claim 1, wherein step S1 specifically comprises: firstly, determining a number k of raindrops in a stochastic rain field, then determining parameters of each raindrop, comprising a diameter, a shape, an impact angle θ and an impact position of each raindrop, and constructing the stochastic rain field model according to relevant attributes of the k raindrops;
(1) the number k of the raindrops is calculated by following formula:
$$P ( N ( V ) = k ) = \frac{{( λ V )}^{k} {e}^{λ V}}{k !}$$
$$λ = 48.88 {I}^{0.15}$$
where λ is an estimated number of raindrops per unit volume, P(N(V)=k) is a probability that there are k raindrops in a volume V, and I is a rain intensity in mm h⁻¹; raindrops are uniformly distributed in a space of the volume V;
a rainfall space volume Vis calculated by the following formula:
V=S×ν×tₛ
where S is a rainfall projection area, i.e., a blade coating area; ν is a relative velocity of raindrop impact, i.e., addition of a blade linear velocity with a raindrop velocity; tₛ is a rainfall duration;
(2) the diameter of each raindrop is calculated by following formula:
$$F = 1 - exp [ - {( \frac{d}{13 {I}^{0.232}} )}^{2.25} ]$$
where F is a cumulative distribution function of a raindrop size d, d is the raindrop size in mm, and I is the rain intensity in mm h⁻¹;
(3) determination of the shape of the raindrop is to determine a type of raindrop according to an occurrence probability of a type of raindrop, and to carry out geometric modeling according to specific types;
the raindrop has a shape which is one of a flat ellipsoid, a spindle ellipsoid or a perfect sphere, the occurrence probabilities of which are 27%, 55% and 18%, respectively; for perfect-sphere raindrops, modeling is directly implemented according to a raindrop radius; for flat-ellipsoid or spindle-ellipsoid raindrops, geometric modeling of raindrops is completed by an axial ratio formula as follow:
a=1.030−0.124r₀
where α is the axial ratio of a minor axis to a major axis, r₀ is an equivalent perfect-sphere raindrop radius, i.e., r₀=d/2;
(4) the impact angle θ of the raindrop follows a uniform distribution of [0, 90°];
(5) the impact position of the raindrop is any position in the blade coating area and is evenly distributed.

3. The method for analyzing wind turbine blade coating fatigue due to rain erosion according to claim 1, wherein S2 specifically comprises the following substeps:
S2.1: constructing a blade model, meshing, setting properties of related composite materials, and setting constraint conditions:
S2.2: according to different sizes and shapes of raindrops, construing different single raindrops, meshing, setting an impact speed and impact angle of the raindrops, using finite element analysis software combined with a smooth fluid dynamics method to implement simulation analysis, and calculating the impact stress of a single raindrop;
S2.3: obtaining Von Mises stresses of various sites on the blade coating in the finite element analysis analysis as the impact stresses;
S2.4: repeating steps S2.2-S2.3 to calculate the impact stress of the raindrops under various conditions, comprising a combination of different raindrop diameters, different raindrop shapes, different impact angles and different impact speeds.

4. The method for analyzing wind turbine blade coating fatigue due to rain erosion according to claim 1, wherein S3 specifically comprises the following substeps:
S3.1: according to the rain field model constructed by S 1, after determining the size, shape, impact angle and speed of a single random raindrop, a circular domain with an impact point as a center and N times of the raindrop diameter as the radius being considered as an area influenced by raindrop impact, wherein N is 9-11;
S3.2: choosing a same type of raindrop shape according to the stress of the raindrop impact in a series of cases obtained in step S2, and searching for stress results of the impact cases that have the closest raindrop diameter, impact angle, and impact speed to interpolate the stress in the circular area;
S3.3: repeat steps S3.1-S3.2 for each raindrop until all the impact stresses caused by k raindrops on the blade are calculated.

5. The method for analyzing wind turbine blade coating fatigue due to rain erosion according to claim 1, wherein S4 specifically comprises the following substeps:
S4.1: selecting the rain intensity I and the rainfall duration tₛ of a single simulation, and calculating the impact stress of the coating in the stochastic rain field according to steps S1 to S3;
S4.2: selecting a local maximum stress and a neighboring minimum stress, or selecting a local minimum stress and a neighboring maximum stress to constitute a half stress cycle, and splitting an impact stress curve into a plurality of half-cyclic stresses with constant amplitudes;
S4.3: for each half-cyclic stress in S4.2, calculating a number of allowable stress cycles N_{f} by using the following formula:
$${σ}_{n}^{′} = \frac{{σ}_{a} UTS}{UTS - {σ}_{m}}$$
$${N}_{f} = {( \frac{{σ}_{a}^{′}}{{σ}_{f}} )}^{1 / b}$$
where σ′ₐ is a corrected stress amplitude, σₐ is a stress amplitude, σₘ is a mean stress, UTS is an ultimate tensile strength, σ_{f} is the fatigue strength coefficient, b is a fatigue strength exponent, wherein UTS, σ_{f} and b are all inherent properties of a coating material, which can be obtained through experiments, while σₐ and σₘ can be calculated according to the maximum stress and minimum stress of the half-cyclic stress;
S4.4: repeating step S4.3 until the number of the allowable stress cycles N_{f} of all half-cyclic stresses is calculated; according to Miner's rule for damage accumulation, a fatigue damage caused by all half-cyclic stresses caused by a raindrop impacting the blade is
$$D = {\sum }_{i} \frac{0.5}{{N}_{f}^{i}}$$
S4.5: repeating steps S4.2-S4.4 until the fatigue damage Dₛ caused by the impact stress of k raindrops on the blade in the rainfall duration tₛ is calculated, and calculating the fatigue life tᵢₙᵢₜᵢₐₜᵢₒₙ of a crack initiation period by the following formula:
$${t}_{initiation} = \frac{{t}_{s}}{{D}_{s}}$$
S4.6: for each half-cyclic stress in S4.2, iteratively calculating a crack length by the following formula:
aᵢ₊₁=aᵢ0.5×C[Y(σₘₐₓ−σₘᵢₙ)\sqrt{πᵢ}]^{m}
where aᵢ₊₁ is a crack length after the half-cyclic stress, σᵢ is a crack length before the half-cyclic stress; C and m are inherent properties of the material, which are obtained through material fatigue experiments; a value of Y is determined by a crack shape, σₘₐₓ is the maximum stress of the half-cyclic stress and σₘᵢₙ is the minimum stress of the half-cyclic stress;
S4.7: repeating steps S4.2 and S4.6 until the crack length a caused by the impact stress of k raindrops on the blade in the rainfall duration tₛ is calculated;
S4.8: if the rain intensity I is greater than or equal to 10 mm h⁻¹, proceeding to step S4.9; if the rain intensity I is less than 10 mm h⁻¹, proceeding to step S4.1;
S4.9: repeating steps S4.1, S4.2, S4.6, S4.7, and the rainfall duration increases continuously, while the crack length increases continuously until the crack length meets the following formula or the crack length is greater than a coating thickness, considering that a crack stable propagation period is completed:
σₘₐₓ\sqrt{πa_{now}}>K_{C}
where σ_{now} is a current crack length, K_{C} is a fracture toughness, which is an inherent property of the material and can be measured by experiments; when the crack length meets the above conditions, the rainfall duration is the fatigue life during the crack stable propagation period;
S4.10: when the rain intensity I is low, calculating an equivalent stress range Δσ within the rainfall duration tₛ by the following formula, and using a constant amplitude cyclic stress of the equivalent stress range Δσ to replace all varied-amplitude cyclic stresses within the rainfall duration tₛ:
$$Δ σ = \{ \begin{matrix}{\{ \frac{2}{{N}_{t} ( m - 2 ) {C ( Y \sqrt{π} )}^{m}} [ {a}_{0}^{( 1 - \frac{m}{2} )} - {a}^{( 1 - \frac{m}{2} )} ] \}}^{\frac{1}{m}} , & m \neq 2 \\ {[ \frac{1}{C {{N}_{t} ( Y \sqrt{π} )}^{m}} ln ( \frac{a}{{a}_{0}} ) ]}^{\frac{1}{m}} , & m = 2\end{matrix}$$
where σ₀ is an initial crack length, a is a crack length after the rainfall duration tₛ and Nₜ is a number of all stress cycles in the rainfall duration tₛ;
the number of allowable stress cycles N_{c} during the crack stable propagation period is calculated by the following formula:
$${N}_{c} = \{ \begin{matrix}\frac{2}{( m - 2 ) {C ( Y Δ σ \sqrt{π} )}^{m}} [ {a}_{0}^{( 1 - \frac{m}{2} )} - {a}_{c}^{( 1 - \frac{m}{2} )} ] , & m \neq 2 \\ \frac{1}{{C ( Y Δ σ \sqrt{π} )}^{m}} ln ( \frac{{a}_{c}}{{a}_{0}} ) , & m = 2\end{matrix} \\ {a}_{C} = {( \frac{{K}_{C}}{Y {σ}_{MAX}} )}^{2} / π$$
where σ_{MAX} is the maximum stress in the rainfall duration tₛ;
the fatigue life of the crack stable propagation period is calculated by the following formula:
$${t}_{propagation} = \frac{{N}_{c}}{{N}_{t}} {t}_{s}$$
S4.11: calculating the fatigue life of the coating at a certain point under the rain intensity I by the following formula:
t_{IP}=tᵢₙᵢₜᵢₐₜᵢₒₙ+t_{propagation}
S4.12: repeating steps S4.1-S4.12 to calculate the fatigue life of each point of the coating, ranking the fatigue lives of all points from small to large, and taking the fatigue life of the 84th percentile as the fatigue life t_{I} of the whole coating.

6. The method for analyzing wind turbine blade coating fatigue due to rain erosion according to claim 1, wherein S5 specifically comprises the following substeps:
S5.1: obtaining annual rainfall data of an area where the wind turbine is located according to relevant statistical data;
S5.2: statistically processing the rainfall data and obtaining an annual rainfall duration t_{A} and a probability of occurrence of each rain intensity P_{I} in the area.
